(19) United States
(12) Patent Application Publication
(10) Pub. No.: US 2019/0056616 A1
(43) Pub. Date: Feb. 21, 2019

(54) ARRAY SUBSTRATE AND LIQUID CRYSTAL DISPLAY DEVICE

(71) Applicants: BOE Technology Group Co., Ltd., Beijing (CN); Chongqing BOE Optoelectronics Technology Co., Ltd., Chongqing (CN)

(72) Inventors: Kai WANG, Beijing (CN); Zhonghao HUANG, Beijing (CN); Gaofei SHI, Beijing (CN)

(21) Appl. No.: 16/003,522

(22) Filed: Jun. 8, 2018

(30) Foreign Application Priority Data
Aug. 21, 2017 (CN) 201710718140.6

(51) Int. Cl. G02F 1/1362; G02F 1/1368; G02F 1/1343; G02F 1/1335

(52) U.S. Cl. CPC G02F 1/13624; G02F 1/136286; G02F 1/1368; G02F 2201/123; G02F 1/133514; G02F 2001/134345; G02F 1/134336

(57) ABSTRACT

The disclosure discloses an array substrate and a liquid crystal display device. The array substrate includes a plurality of data lines paralleled with each other, and a plurality of scan lines perpendicularly intersected with the plurality of data line, wherein the plurality of data lines are insulated from the plurality of scan lines at their intersections; and the array substrate further includes pixel electrodes, wherein each pixel electrode is driven by n thin film transistors sharing a same data line and a same scan line, wherein n is a positive integer greater than or equal to 2.

### CROSS-REFERENCE TO RELATED APPLICATION

This Application claims priority to Chinese Patent Application No. 201710718140.6, filed on Aug. 21, 2017, the content of which is incorporated by reference in the entirety.

### TECHNICAL FIELD

This disclosure relates to the field of liquid crystal displays, and particularly to an array substrate and a liquid crystal display device.

### DESCRIPTION OF RELATED ART

A thin film transistor is a crucial component in a thin film transistor liquid crystal display device in the related art. In order to achieve a higher display quality, the characteristic of the thin film transistor needs being improved constantly. Many existing researches are focused on an increase in width to length ratio of a channel of the thin film transistor to increase turn-on current of the thin film transistor. The width to length ratio of the channel of the thin film transistor is limited in a process of fabricating the thin film transistor, so there is a limited increase of the turn-on current thereof, thus degrading the efficiency of charging a pixel electrode.

### SUMMARY

Embodiments of the disclosure provide an array substrate and a liquid crystal display device.

In an aspect, the embodiments of the disclosure provide an array substrate including a plurality of data lines paralleled with each other, and a plurality of scan lines perpendicularly intersected with the plurality of data lines, wherein the plurality of data lines are insulated from the plurality of scan lines at their intersections; and the array substrate further includes pixel electrodes, wherein each pixel electrode is driven by n thin film transistors sharing a same data line and a same scan line, wherein n is a positive integer greater than or equal to 2.

In some embodiments, the plurality of data lines and the plurality of scan lines intersect with each other to define a plurality of accommodating areas; and each pixel electrode traverses two adjacent accommodating areas, and a data line or a scan line between them, and is insulated from the data line or the scan line traversed by the each pixel electrode; wherein the data line or the scan line traversed by the each pixel electrode is a first conductive line, and data lines or scan lines intersecting with the first conductive line are second conductive lines; and n thin film transistors for driving a same pixel electrode share a first conductive line traversed by the same pixel electrode, and a same one of second conductive lines intersecting with the first conductive line traversed by the same pixel electrode.

In some embodiments, the n thin film transistors for driving the same pixel electrode are located on two sides of the first conductive line traversed by the same pixel electrode.

In some embodiments, a number of thin film transistors for driving the same pixel electrode is two.

In some embodiments, each pixel electrode is symmetric with respect to the data line or the scan line traversed by the each pixel electrode.

In some embodiments, each accommodating area includes parts of two pixel electrodes, and there is a gap between the two pixel electrodes in the each accommodating area.

In some embodiments, two adjacent pixel electrodes are arranged symmetric with respect to an axis which is a center line between two first conductive lines traversed by the two adjacent pixel electrodes.

In some embodiments, drains of n thin film transistors for driving a same pixel electrode are connected with the same pixel electrode, sources of the n thin film transistors for driving the same pixel electrode are connected with a same data line, and gates of the n thin film transistors for driving the same pixel electrode are connected with a same scan line; and the sources of the n thin film transistors for driving the same pixel electrode are formed integrally with a data line connected therewith, and the gates of the n thin film transistors for driving the same pixel electrode are formed integrally with a scan line connected therewith.

In some embodiments, the array substrate further includes a common electrode and a color filter layer; and the color filter layer includes an array of pixels, and each pixel in the array of pixels includes a plurality of sub-pixels; and the plurality of sub-pixels correspond to the pixel electrodes in a one-to-one manner.

In another aspect, the embodiments of the disclosure further provide a liquid crystal display device, including a color filter substrate and an array substrate box-aligned with each other, and liquid crystals filled between them; and the array substrate includes a plurality of data lines paralleled with each other, and a plurality of scan lines perpendicularly intersected with the plurality of data lines, wherein the plurality of data lines are insulated from the plurality of scan lines at their intersections; and the array substrate further includes pixel electrodes, wherein each pixel electrode is driven by n thin film transistors sharing a same data line and a same scan line, wherein n is a positive integer greater than or equal to 2.

In some embodiments, the plurality of data lines and the plurality of scan lines intersect with each other to define a plurality of accommodating areas; and each pixel electrode traverses two adjacent accommodating areas, and a data line or a scan line between them, and is insulated from the data line or the scan line traversed by the each pixel electrode; wherein the data line or the scan line traversed by the each pixel electrode is a first conductive line, and data lines or scan lines intersecting with the first conductive line are second conductive lines; and n thin film transistors for driving a same pixel electrode share a first conductive line traversed by the same pixel electrode, and a same one of second conductive lines intersecting with the first conductive line traversed by the same pixel electrode.

In some embodiments, the n thin film transistors for driving the same pixel electrode are located on two sides of the first conductive line traversed by the same pixel electrode.

In some embodiments, a number of thin film transistors for driving the same pixel electrode is two.

In some embodiments, each pixel electrode is symmetric with respect to the data line or the scan line traversed by the each pixel electrode.

In some embodiments, each accommodating area includes parts of two pixel electrodes, and there is a gap between the two pixel electrodes in the each accommodating area.

In some embodiments, two adjacent pixel electrodes are arranged symmetric with respect to an axis which is a center line between two first conductive lines traversed by the two adjacent pixel electrodes.

In some embodiments, drains of n thin film transistors for driving a same pixel electrode are connected with the same pixel electrode, sources of the n thin film transistors for driving the same pixel electrode are connected with a same data line, and gates of the n thin film transistors for driving the same pixel electrode are connected with a same scan line; and the sources of the n thin film transistors for driving the same pixel electrode are formed integrally with a data line connected therewith, and the gates of the n thin film transistors for driving the same pixel electrode are formed integrally with a scan line connected therewith.

In some embodiments, the array substrate further includes a common electrode and a color filter layer; and the color filter layer includes an array of pixels, and each pixel in the array of pixels includes a plurality of sub-pixels; and the plurality of sub-pixels correspond to the pixel electrodes in a one-to-one manner.

### BRIEF DESCRIPTION OF THE DRAWINGS

In order to make the technical solutions according to embodiments of the disclosure more apparent, the drawings to which a description of the embodiments refers will be briefly introduced below, and apparently the drawings to be described below are merely illustrative of some of the embodiments of the disclosure, and those ordinarily skilled in the art can derive from these drawings other drawings without any inventive effort.

FIG. 1 is a first schematic diagram of a part of an array substrate according to the embodiments of the disclosure;

FIG. 2 is a second schematic diagram of a part of an array substrate according to the embodiments of the disclosure;

FIG. 3 is a third schematic diagram of a part of an array substrate according to the embodiments of the disclosure; and

FIG. 4 is a schematic diagram of a part of a liquid crystal display device according to the embodiments of the disclosure.

### DETAILED DESCRIPTION OF THE EMBODIMENTS

The technical solutions according to the embodiments of the disclosure will be described below clearly and fully with reference to the drawings in the embodiments of the disclosure, and apparently the embodiments to be described are only a part but not all of the embodiments of the disclosure. Based upon the embodiments here of the disclosure, all the other embodiments which can occur to those ordinarily skilled in the art without any inventive effort shall fall into the scope of the disclosure.

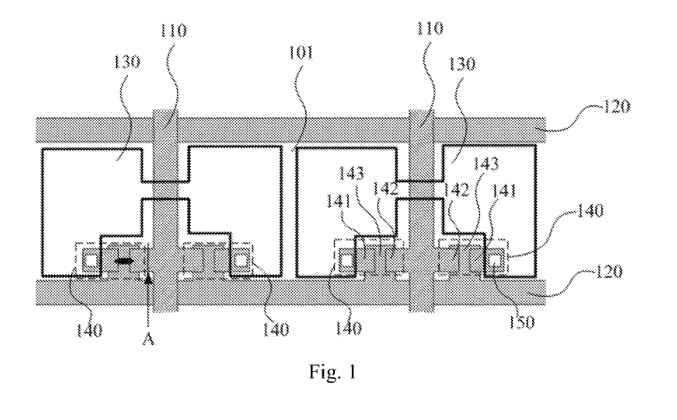

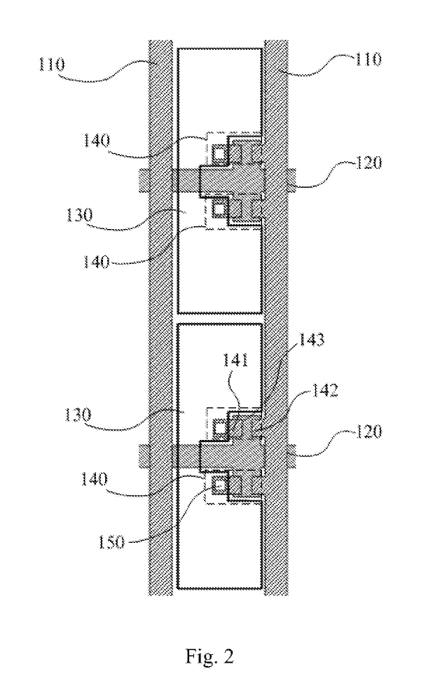

The embodiments of the disclosure provide an array substrate, as illustrated in FIG. 1 and FIG. 2, the array substrate includes a plurality of data lines 110 paralleled with each other, and a plurality of scan lines 120 perpendicularly intersected with the plurality of data lines 110, wherein the plurality of data lines 110 are insulated from the plurality of scan lines 120 at their intersections.

The array substrate further includes pixel electrodes 130, and each pixel electrode 130 is driven by n thin film transistors 140 sharing the same data line and the same scan line, where n is a positive integer greater than or equal to 2.

In the array substrate above according to the embodiments of the disclosure, since each pixel electrode is driven by n thin film transistors sharing the same data line and the same scan line, when all the n thin film transistors for driving the pixel electrode can charge the pixel electrode, the n thin film transistors for driving the pixel electrode can be equivalent to one thin film transistor, and a width to length ratio of a channel of this equivalent thin film transistor is n times a width to length ratio of a channel of a single actual thin film transistor. In this way, the width to length ratio of the channel of this equivalent thin film transistor increases to thereby raise turn-on current thereof so as to improve the efficiency of charging the pixel electrode. While each pixel electrode in an array substrate in the related art is driven by one actual thin film transistor, and a width to length ratio of a channel of the actual thin film transistor is limited due to the precision of fabrication thereof, so there is a limited increase of turn-on current thereof. Where it should be noted that, the channel in the thin film transistor is an area between a source and a drain of the thin film transistor, where the distance between the source and the drain is the width of the channel, and the length of the source and the drain in a direction perpendicular to a width direction of the channel is the length of the channel.

Further, each pixel electrode in the array substrate in the related art is driven by one thin film transistor, and when this only thin film transistor is damaged and cannot charge the pixel electrode, this pixel electrode cannot be charged. However, in the array substrate above according to the embodiments of the disclosure, when one or more of n thin film transistors for driving a same pixel electrode is or are damaged and cannot charge the pixel electrode, the damaged thin film transistor(s) can be disconnected and will not charge the pixel electrode any longer, and the other thin film transistor(s) still can charge the pixel electrode. That is, even if one or more of the n thin film transistors is or are damaged, the array substrate according to the embodiments of the disclosure will be less influenced.

In some embodiments, each pixel electrode is made of indium tin oxide, indium doped zinc oxide, or another transparent metal oxide.

In some embodiments, in order to enable n thin film transistors for driving the same pixel electrode to drive the same pixel electrode, as illustrated in FIG. 1 and FIG. 2, the following structure and connections are provided.

Drains 141 of n thin film transistors for driving the same pixel electrode 130 are connected with the same pixel electrode 130, sources 142 of the n thin film transistors for driving the same pixel electrode 130 are connected with a same data line 110, and gates 143 of the n thin film transistors for driving the same pixel electrode 130 are connected with a same scan line 120.

In a process of fabricating a thin film transistor in the related art, a mask with a single aperture is often used, and for the thin film transistor fabricated using the mask with the single aperture, a source and a drain of the same thin film transistor tend to be connected directly with each other, thus resulting in short circuit between them. And each pixel electrode in the array substrate in the related art is driven by one thin film transistor, and when short circuit occurs between a source and a drain of this only thin film transistor, the pixel electrode cannot be charged. In some embodiments, in the embodiments of the disclosure, for the n thin film transistors for driving a same pixel electrode, when a source and a drain of one thin film transistor are connected by a conductor, e.g., a metal particle, thus resulting in short circuit between them, the source of the short-circuited thin film transistor can be disconnected with a data line at a position A in FIG. 1, so that the thin film transistor will not drive the pixel electrode any longer, and the other thin film transistor(s) still can charge the pixel electrode, where an oval in FIG. 1 represents the short circuit caused by the metal particle connecting the source and the drain. That is, even if a source and a drain of a thin film transistor are short-circuited, the array substrate according to the embodiments of the disclosure will be less influenced.

In some embodiments, in order to simplify the structure of the array substrate, and to alleviate an influence on the array substrate, as illustrated in FIG. 1 and FIG. 2, n thin film transistors for driving the same pixel electrode, and the same data line and the same scan line shared by them are positioned as follows.

The plurality of data lines 110 and the plurality of scan lines 120 intersect with each other to define a plurality of accommodating areas 101; and each pixel electrode 130 traverses two adjacent accommodating areas 101, and a data line 110 or a scan line 120 between them, and is insulated from the data line 110 or the scan line 120 traversed by the each pixel electrode. FIG. 1 is a first schematic diagram of a part of an array substrate according to the embodiments of the disclosure, and as illustrated in FIG. 1, each pixel electrode 130 traverses two adjacent accommodating areas 101, and a data line 110 between them; and FIG. 2 is a second schematic diagram of a part of an array substrate according to the embodiments of the disclosure, and as illustrated in FIG. 1, each pixel electrode 130 traverses two adjacent accommodating areas 101, and a scan line 120 between them. Where the data line or the scan line traversed by the each pixel electrode is a first conductive line, and data lines or scan lines intersecting with the first conductive line are second conductive lines.

Where n thin film transistors for driving a same pixel electrode share a first conductive line traversed by the same pixel electrode, and the same one of second conductive lines intersecting with the first conductive line traversed by the same pixel electrode.

They are positioned in this way so that both the first conductive line and the second conductive line shared by the n thin film transistors for driving the same pixel electrode are close to the n thin film transistors, thus simplifying the structure of the array substrate.

In some embodiments, as illustrated in FIG. 1 and FIG. 2, a length, of each pixel electrode 130 at a position where it traverses two adjacent accommodating areas and a first conductive line between them, along a length direction of the first conductive line is smaller than a length, of the pixel electrode 130 in the accommodating areas 101, along the length direction of the first conductive line. That is, there is a smaller overlapping part between the pixel electrode and the first conductive line at the position where the pixel electrode traverses the two adjacent accommodating areas and the first conductive line. This arrangement is advantageous in a less influence, of the pixel electrode overlapping with the first conductive line at the position where the pixel electrode traverses the two adjacent accommodating areas and the first conductive line, on the array substrate.

In some embodiments, as illustrated in FIG. 1 and FIG. 2, the n thin film transistors for driving the same pixel electrode are located on two sides of the first conductive line traversed by the same pixel electrode.

The n thin film transistors are arranged in this way so that both the first conductive line and the second conductive line shared by the n thin film transistors for driving the same pixel electrode are close to the n thin film transistors, thus simplifying the structure of the array substrate.

In some embodiments, as illustrated in FIG. 1 and FIG. 2, the number of thin film transistors for driving the same pixel electrode is two, and such an array substrate can be simplified in structure, and fabricated in a simple process.

In some embodiments, in order to simplify the process of fabricating the array substrate, the pixel electrodes are arranged in a same rule, and the pixel electrodes are symmetric with respect to the data lines or the scan lines traversed by them. The pixel electrodes are arranged in a uniform patter to thereby simplify both the process of fabricating the array substrate, and the array substrate in structure.

In some embodiments, each pixel electrode traverses two adjacent accommodating areas, and there is only a part of this pixel electrode in each of the two adjacent accommodating areas. In some embodiments, as illustrated in FIG. 2, each pixel electrode 130 traverses two adjacent accommodating areas 101, and there are both a part of this pixel electrode 130, and a part of an adjacent pixel electrode 130 in each of the two adjacent accommodating areas, that is, there are parts of two pixel electrodes 130 in each accommodating area 101, and there is a gap between the two pixel electrodes 130 in the each accommodating area. Where the size of a pixel electrode is related to a sub-pixel of a color filter substrate operating in cooperation with the array substrate.

In some embodiments, as illustrated in FIG. 1 and FIG. 2, two adjacent pixel electrodes 130 are arranged symmetric with respect to an axis which is a center line between two first conductive lines traversed by the two adjacent pixel electrodes. The pixel electrodes are arranged in a uniform pattern to thereby simplify both the process of fabricating the array substrate, and the array substrate in structure.

In some embodiments, in order to further simplify the array substrate in structure, as illustrated in FIG. 1 and FIG. 2, sources 142 of thin film transistors for driving the same pixel electrode are formed integrally with a data line 110 connected therewith, and gates 143 of the thin film transistors for driving the same pixel electrode are formed integrally with a scan line 120 connected therewith. Therefore, the sources of the thin film transistors for driving the same pixel electrode, and the data line connected therewith can be formed directly in one process to thereby simplify the process of fabricating the array substrate; and the gates of the thin film transistors for driving the same pixel electrode, and the scan line connected therewith can be formed directly in one process to thereby simplify the process of fabricating the array substrate.

In some embodiments, as illustrated in FIG. 1 and FIG. 2, a drain 142 is connected with a corresponding pixel electrode 130 as follows: there is an insulation layer between the drain 142 and the pixel electrode 130, there are through-holes 150 arranged on the drain 142 and the insulation layer, and the drain and the pixel electrode are connected with an electric connection structure through the through-holes 150.

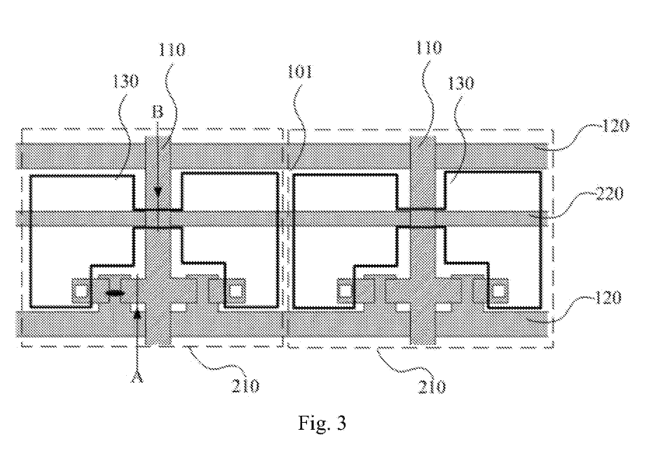

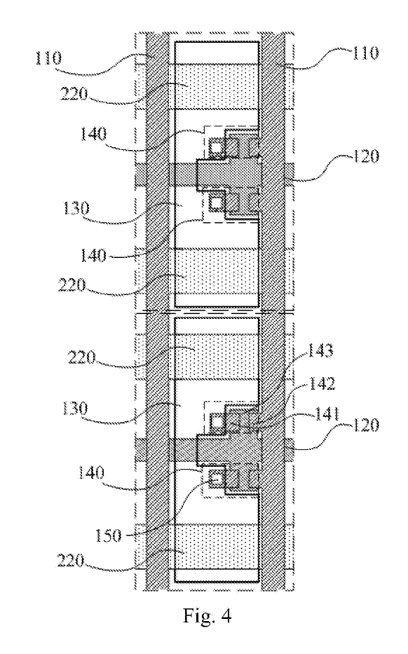

In some embodiments, as illustrated in FIG. 3 and FIG. 4, the array substrate according to the embodiments of the disclosure further includes a common electrode 220 and a color filter layer; and the color filter layer includes an array of pixels, and each pixel in the array of pixels includes a plurality of sub-pixels 210; and the sub-pixels 210 correspond to the pixel electrodes 130 in a one-to-one manner.

Where, in the array substrate according to the embodiments of the disclosure, the voltage of the pixel electrodes 130 is adjusted to thereby adjust the strength of an electric field between the pixel electrodes 130 and the common electrode 220.

In some embodiments, the pixels can be pixels including red sub-pixels (R), green sub-pixels (G), and blue sub-pixels (B), can be pixels including red sub-pixels (R), green sub-pixels (G), blue sub-pixels (B), and white sub-pixels (W), etc.

It should be noted that, in the array substrate according to the embodiments of the disclosure, both the common electrode and the color filter layer are arranged on the array substrate. In some embodiments, both the common electrode and the color filter layer can alternatively be arranged on a color filter substrate instead of the array substrate.

The embodiments of the disclosure further provide a liquid crystal display device, the liquid crystal display device includes a color filter substrate and an array substrate box-aligned with each other, and liquid crystals filled between them; where the array substrate is the array substrate above according to the embodiments of the disclosure. And reference can be made to the embodiments of the array substrate above for an implementation of the display panel, so a repeated description thereof will be omitted here.

Where, in the liquid crystal display device according to the embodiments of the disclosure, the voltage of the pixel electrodes of the array substrate is adjusted to thereby adjust the strength of an electric field between the pixel electrodes and the common electrode so as to control the liquid crystals to be deflected, to control the brightness of light of sub-pixels corresponding to the pixel electrodes.

Further, in the liquid crystal display device according to the embodiments of the disclosure, the number of thin film transistors for driving the same pixel electrode is n, and when all the n thin film transistors for driving the same pixel electrode can charge the pixel electrode, the n thin film transistors for driving the same pixel electrode can be equivalent to one thin film transistor, and a width to length ratio of a channel of this equivalent thin film transistor is n times a width to length ratio of a channel of a single actual thin film transistor. In this way, the width to length ratio of the channel of the equivalent thin film transistor can be equivalently increased to thereby raise turn-on current thereof so as to improve the display quality of the liquid crystal display device. Furthermore when short circuit occurs between a source and a drain of one of n thin film transistors for driving the same pixel electrode, as illustrated in FIG. 3, the oval structure connects the source with the drain, thus resulting in short circuit between them, the source of the short-circuited thin film transistor can be disconnected with the data line at the position A in FIG. 1, so the short-circuited thin film transistor will not drive the pixel electrode any longer, and the other thin film transistor(s) still can charge the pixel electrode. Furthermore when one or more of n thin film transistors for driving the same pixel electrode is or are damaged, the part(s) of the pixel electrode, which is or are to be charged by the damaged thin film transistor(s) can be cut off at the position B in FIG. 3, so that the thin film transistor(s) which is or are not damaged can charge the remaining pixel electrode without being influenced or while being less influenced. That is, the voltage of the remaining pixel electrode can be adjusted without being influenced or while being less influenced, so there is no influence or a less influence on the strength of an electric field in the liquid crystal layer between the remaining pixel electrode and the common electrode, thus lowering the possibility of color shift at the sub-pixel corresponding to the remaining pixel electrode. While each pixel electrode in the array substrate of the liquid crystal display device in the related art is driven by one thin film transistor, and when this only thin film transistor is damaged and cannot charge the pixel electrode, this pixel electrode cannot be charged, and a dark dot is displayed at a sub-pixel corresponding thereto. Accordingly the possibility of a dark dot occurring at the sub-pixel in the liquid crystal display device according to the embodiments of the disclosure can be greatly lowered, and the product yield and the display quality of the liquid crystal display device according to the embodiments of the disclosure can be greatly improved.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. An array substrate, comprising a plurality of data lines paralleled with each other, and a plurality of scan lines perpendicularly intersected with the plurality of data lines, wherein the plurality of data lines are insulated from the plurality of scan lines at their intersections; and
the array substrate further comprises pixel electrodes, wherein each pixel electrode is driven by n thin film transistors sharing a same data line and a same scan line, wherein n is a positive integer greater than or equal to 2.

2. The array substrate according to claim 1, wherein the plurality of data lines and the plurality of scan lines intersect with each other to define a plurality of accommodating areas; and each pixel electrode traverses two adjacent accommodating areas, and a data line or a scan line between them, and is insulated from the data line or the scan line traversed by the each pixel electrode; wherein the data line or the scan line traversed by the each pixel electrode is a first conductive line, and data lines or scan lines intersecting with the first conductive line are second conductive lines; and
n thin film transistors for driving a same pixel electrode share a first conductive line traversed by the same pixel electrode, and a same one of second conductive lines intersecting with the first conductive line traversed by the same pixel electrode.

3. The array substrate according to claim 2, wherein the n thin film transistors for driving the same pixel electrode are located on two sides of the first conductive line traversed by the same pixel electrode.

4. The array substrate according to claim 3, wherein a number of thin film transistors for driving the same pixel electrode is two.

5. The array substrate according to claim 2, wherein each pixel electrode is symmetric with respect to the data line or the scan line traversed by the each pixel electrode.

6. The array substrate according to claim 5, wherein each accommodating area comprises parts of two pixel electrodes, and there is a gap between the two pixel electrodes in the each accommodating area.

7. The array substrate according to claim 6, wherein two adjacent pixel electrodes are arranged symmetric with respect to an axis which is a center line between two first conductive lines traversed by the two adjacent pixel electrodes.

8. The array substrate according to claim 1, wherein drains of n thin film transistors for driving a same pixel electrode are connected with the same pixel electrode, sources of the n thin film transistors for driving the same pixel electrode are connected with a same data line, and gates of the n thin film transistors for driving the same pixel electrode are connected with a same scan line; and
the sources of the n thin film transistors for driving the same pixel electrode are formed integrally with a data line connected therewith, and the gates of the n thin film transistors for driving the same pixel electrode are formed integrally with a scan line connected therewith.

9. The array substrate according to claim 1, wherein the array substrate further comprises a common electrode and a color filter layer; and the color filter layer comprises an array of pixels, and each pixel in the array of pixels comprises a plurality of sub-pixels; and the plurality of sub-pixels correspond to the pixel electrodes in a one-to-one manner.

10. A liquid crystal display device, comprising a color filter substrate and an array substrate box-aligned with each other, and liquid crystals filled between them; and the array substrate comprises a plurality of data lines paralleled with each other, and a plurality of scan lines perpendicularly intersected with the plurality of data lines, wherein the plurality of data lines are insulated from the plurality of scan lines at their intersections; and
the array substrate further comprises pixel electrodes, wherein each pixel electrode is driven by n thin film transistors sharing a same data line and a same scan line, wherein n is a positive integer greater than or equal to 2.

11. The liquid crystal display device according to claim 10, wherein the plurality of data lines and the plurality of scan lines intersect with each other to define a plurality of accommodating areas; and each pixel electrode traverses two adjacent accommodating areas, and a data line or a scan line between them, and is insulated from the data line or the scan line traversed by the each pixel electrode; wherein the data line or the scan line traversed by the each pixel electrode is a first conductive line, and data lines or scan lines intersecting with the first conductive line are second conductive lines; and
n thin film transistors for driving a same pixel electrode share a first conductive line traversed by the same pixel electrode, and a same one of second conductive lines intersecting with the first conductive line traversed by the same pixel electrode.

12. The liquid crystal display device according to claim 11, wherein the n thin film transistors for driving the same pixel electrode are located on two sides of the first conductive line traversed by the same pixel electrode.

13. The liquid crystal display device according to claim 12, wherein a number of thin film transistors for driving the same pixel electrode is two.

14. The liquid crystal display device according to claim 11, wherein each pixel electrode is symmetric with respect to the data line or the scan line traversed by the each pixel electrode.

15. The liquid crystal display device according to claim 14, wherein each accommodating area comprises parts of two pixel electrodes, and there is a gap between the two pixel electrodes in the each accommodating area.

16. The liquid crystal display device according to claim 15, wherein two adjacent pixel electrodes are arranged symmetric with respect to an axis which is a center line between two first conductive lines traversed by the two adjacent pixel electrodes.

17. The liquid crystal display device according to claim 10, wherein drains of n thin film transistors for driving a same pixel electrode are connected with the same pixel electrode, sources of the n thin film transistors for driving the same pixel electrode are connected with a same data line, and gates of the n thin film transistors for driving the same pixel electrode are connected with a same scan line; and
the sources of the n thin film transistors for driving the same pixel electrode are formed integrally with a data line connected therewith, and the gates of the n thin film transistors for driving the same pixel electrode are formed integrally with a scan line connected therewith.

18. The liquid crystal display device according to claim 10, wherein the array substrate further comprises a common electrode and a color filter layer; and the color filter layer comprises an array of pixels, and each pixel in the array of pixels comprises a plurality of sub-pixels; and the plurality of sub-pixels correspond to the pixel electrodes in a one-to-one manner.
